(19) United States
(12) Patent Application Publication
(10) Pub. No.: US 2016/0026672 A1
(43) Pub. Date: Jan. 28, 2016

(54) DATA AND METADATA CONSISTENCY IN OBJECT STORAGE SYSTEMS

(71) Applicant: NetApp. Inc., Sunnyvalle, CA (US)

(72) Inventors: Yi Zhang, Vancouver (CA); Alvin Lam, Vancouver (CA); Oliver Erik Seiler, New Westminster (CA)

(21) Appl. No.: 14/339,119

(22) Filed: Jul. 23, 2014

(51) Int. Cl. G06F 17/30

(52) U.S. Cl. CPC G06F 17/30371; G06F 17/30864; G06F 17/30997; G06F 17/30368; G06F 17/30507

(57) ABSTRACT

Technology is disclosed for maintaining consistency between data and metadata of an object storage system. The object storage system stores a single copy of the data object in the object storage system and creates metadata associated with the data object in a metadata database of the object storage system. The metadata can include a copy number of the data object. The object storage system receives a signal indicating that no copy of the data object can be found or accessed. In response to the signal, the object storage system determines that the copy number of the data objects indicates that there is only one copy of the data object stored in the object storage system. Based on an object identifier included in the signal, the object storage system removes the metadata associated with the data object from the metadata database

### BACKGROUND

Clusters of computing devices can be used to facilitate efficient and cost effective storage of large amounts of digital data. For example, a clustered network environment of computing devices (“nodes”) may be implemented as a data storage system to facilitate the creation, storage, retrieval, and/or processing of digital data. Such a data storage system may be implemented using a variety of storage architectures, such as a network-attached storage (NAS) environment, a storage area network (SAN), a direct-attached storage environment, and combinations thereof. The data storage systems may comprise one or more data storage devices configured to store digital data within data volumes.

Digital data stored by data storage systems may be frequently migrated within the data storage system and/or between data storage systems, such as by copying, moving, replication, backing up, restoring, etc. For example, a user may move files, folders, or even the entire contents of a data volume from one data volume to another data volume. Likewise, a data replication service may replicate the contents of a data volume across nodes within the data storage system. Irrespective of the particular type of data migration performed, migrating large amounts of digital data may consume significant amounts of available resources, such as central processing unit (CPU) utilization, processing time, network bandwidth, etc. Moreover, migrating digital data may take substantial amounts of time to complete the migration between the source and destination.

### BRIEF DESCRIPTION OF THE DRAWINGS

These and other objects, features and characteristics of the disclosure will become more apparent to those skilled in the art from a study of the following detailed description in conjunction with the appended claims and drawings, all of which form a part of this specification. In the drawings:

FIG. 1 is a block diagram illustrating a clustered network storage environment, in which the technology can operate in various embodiments.

FIG. 2 is a block diagram illustrating a storage operating system, according to various embodiments

FIG. 3 is a block diagram illustrating a buffer tree of a file, in various embodiments.

FIG. 4 is a block diagram illustrating components of a distributed object storage system, according to various embodiments.

FIG. 5 is a block diagram illustrating a geographically distributed site servers of an object storage system.

FIG. 6 is a block diagram illustrating components of a control node and an administration node of an object storage system.

FIG. 7 is a flow diagram illustrating a process for maintaining consistency between data and metadata of an object storage system, in various embodiments.

FIG. 8 is a flow diagram illustrating a process for notifying a loss of a data object, in various embodiments.

FIG. 9 is a high-level block diagram showing an example of computer system in which at least some operations related to technology disclosed herein can be implemented.

### DETAILED DESCRIPTION

References in this specification to “an embodiment,” “one embodiment,” or the like, mean that the particular feature, structure, or characteristic being described is included in at least one embodiment of the disclosure. Occurrences of such phrases in this specification do not all necessarily refer to the same embodiment or all embodiments, however.

Technology is disclosed herein (“the technology”) for maintaining consistency between the data and metadata of data objects in an object storage system that is configured to store only a single copy of an object. Users may use or configure an object storage system to store only a single copy of a particular data object. For example, a user of the object storage system may be able to only afford the cost of a storage service that allows storing single copies of data objects, may have an agreement with another party that only a single copy of a particular data object is to be stored, or a statute or a regulation may require a copy of a particular data object as a backup.

Regardless of the reason why only a single copy is stored, the object storage system may have no redundant data to aid recover when the single copy of the data object is corrupt or lost. The object storage system may waste hardware resources trying to recover the data if the object storage system continues to try retrieving redundant copies of the data object, as is typically the case. The disclosed technology avoids the waste of resources by not engaging the object recovery process. Furthermore, the technology locates and removes the metadata associated with the lost data object to maintain consistency between the data and the metadata. The technology thus optimizes the performance and storage space efficiency of the object storage system.

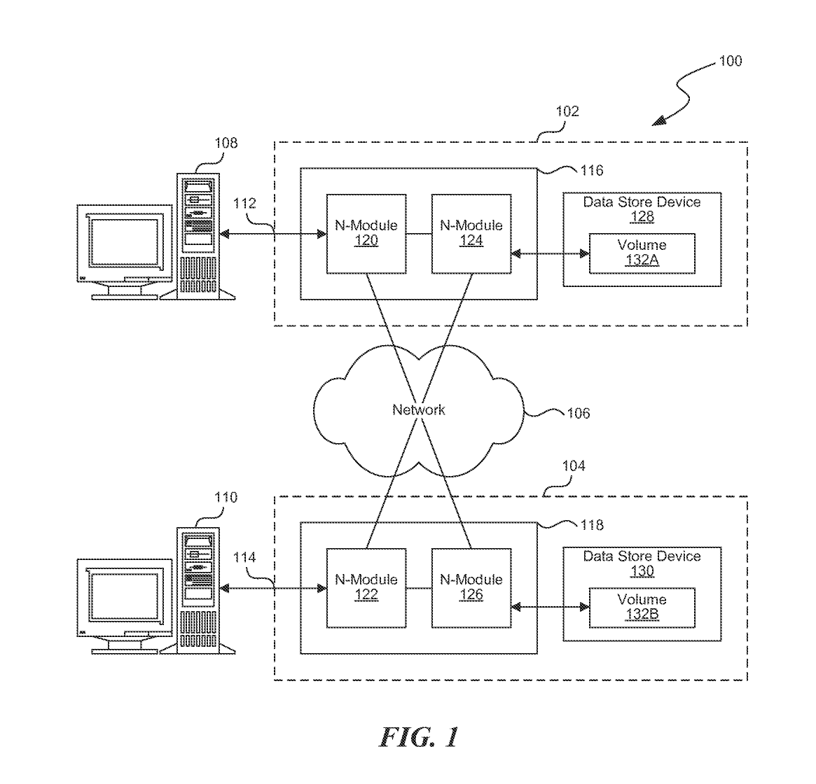

Turning now to the figures, FIG. 1 is a block diagram illustrating a clustered network storage environment, in which the technology can operate in various embodiments. System 100 of FIG. 1 comprises data storage systems 102 and 104 that are coupled via network 106. Data storage systems 102 and 104 can comprise one or more modules, components, etc. operable to provide operation as described herein. For example, data storage systems 102 and 104 can comprise nodes 116 and 118 and data storage devices 128 and 130, respectively. It should be appreciated that nodes and/or data storage devices of data storage systems 102 and 104 may themselves comprise one or more modules, components, etc. Nodes 116 and 118 comprise network modules (referred to herein as “N-Modules”) 120 and 122 and data modules (referred to herein as “D-Modules”) 124 and 126, respectively. Data storage devices 128 and 130 comprise volumes 132A and 132B of user and/or other data, respectively.

The modules, components, etc. of data storage systems 102 and 104 may comprise various configurations suitable for providing operation as described herein. For example, nodes 116 and 118 may comprise processor-based systems, e.g., file server systems, computer appliances, computer workstations, etc. Accordingly, nodes 116 and 118 of embodiments comprise a processor (e.g., central processing unit (CPU), application specific integrated circuit (ASIC), programmable gate array (PGA), etc.), memory (e.g., random access memory (RAM), read only memory (ROM), disk memory, optical memory, flash memory, etc.), and suitable input/output circuitry (e.g., network interface card (NIC), wireless network interface, display, keyboard, data bus, etc.). The foregoing processor-based systems may operate under control of an instruction set (e.g., software, firmware, applet, code, etc.) providing operation as described herein.

Examples of data storage devices 128 and 130 are hard disk drives, solid state drives, flash memory cards, optical drives, etc., and/or other suitable computer readable storage media. Data modules 124 and 130 of nodes 116 and 118 may be adapted to communicate with data storage devices 128 and 130 according to a storage area network (SAN) protocol (e.g., small computer system interface (SCSI), fiber channel protocol (FCP), INFINIBAND, etc.) and thus data storage devices 128 and 130 may appear a locally attached resources to the operating system. That is, as seen from an operating system on nodes 116 and 118, data storage devices 128 and 130 may appear as locally attached to the operating system. In this manner, nodes 116 and 118 may access data blocks through the operating system, rather than expressly requesting abstract files.

Network modules 120 and 122 may be configured to allow nodes 116 and 118 to connect with client systems, such as clients 108 and 110 over network connections 112 and 114, to allow the clients to access data stored in data storage systems 102 and 104. Moreover, network modules 120 and 122 may provide connections with one or more other components of system 100, such as through network 106. For example, network module 120 of node 116 may access data storage device 130 via communication via network 106 and data module 126 of node, 118. The foregoing operation provides a distributed storage system configuration for system 100.

Clients 108 and 110 of embodiments comprise a processor (e.g., CPU, ASIC, PGA, etc.), memory (e.g., RAM, ROM, disk memory, optical memory, flash memory, etc.), and suitable input/output circuitry (e.g., NIC, wireless network interface, display, keyboard, data bus, etc.). The foregoing processor-based systems may operate under control of an instruction set (e.g., software, firmware, applet, code, etc.) providing operation as described herein.

Network 106 may comprise various forms of communication infrastructure, such as a SAN, the Internet, the public switched telephone network (PSTN), a local area network (LAN), a metropolitan area network (MAN), a wide area network (WAN), a wireless network (e.g., a cellular communication network, a wireless LAN, etc.), and/or the like. Network 106, or a portion thereof may provide infrastructure of network connections 112 and 114 or, alternatively, network connections 112 and/or 114 may be provided by network infrastructure separate from network 106, wherein such separate network infrastructure may itself comprise a SAN, the Internet, the PSTN, a LAN, a MAN, a WAN, a wireless network, and/or the like.

As can be appreciated from the foregoing, system 100 provides a data storage system in which various digital data may be created, maintained, modified, accessed, and migrated (referred to collectively as data management). A logical mapping scheme providing logical data block mapping information, stored within and stored without the data structures, may be utilized by system 100 in providing such data management. For example, data files stored in the data storage device 128 can be migrated to the data storage device 130 through the network 106.

In some embodiments, data storage devices 128 and 130 comprise volumes (shown as volumes 132A and 132B respectively), which is an implementation of storage of information onto disk drives, disk arrays, and/or other data stores (e.g., flash memory) as a file-system for data, for example. Volumes can span a portion of a data store, a collection of data stores, or portions of data stores, for example, and typically define an overall logical arrangement of file storage on data store space in the storage system. In some embodiments a volume can comprise stored data as one or more files that reside in a hierarchical directory structure within the volume.

Volumes are typically configured in formats that may be associated with particular storage systems, and respective volume formats typically comprise features that provide functionality to the volumes, such as providing ability for volumes to form clusters. For example, where a first storage system may utilize a first format for their volumes, a second storage system may utilize a second format for their volumes.

In the configuration illustrated in system 100, clients 108 and 110 can utilize data storage systems 102 and 104 to store and retrieve data from volumes 132. In such an embodiment, for example, client 108 can send data packets to N-module 120 in node 116 within data storage system 102. Node 116 can forward the data to data storage device 128 using D-module 124, where data storage device 128 comprises volume 132A. In this way, the client can access storage volume 132A, to store and/or retrieve data, using data storage system 102 connected by network connection 112. Further, in this embodiment, client 110 can exchange data with N-module 122 in node 118 within data storage system 104 (e.g., which may be remote from data storage system 102). Node 118 can forward the data to data storage device 130 using D-module 126, thereby accessing volume 132B associated with the data storage device 130.

The foregoing data storage devices each comprise a plurality of data blocks, according to embodiments herein, which may be used to provide various logical and/or physical storage containers, such as files, container files holding volumes, aggregates, virtual disks, etc. Such logical and physical storage containers may be defined using an array of blocks indexed or mapped either logically or physically by the filesystem using the appropriate type of block number. For example, a file may be indexed by file block numbers (FBNs), a container file by virtual block numbers (VBNs), an aggregate by physical block numbers (PBNs), and disks by disk block numbers (DBNs). To translate an FBN to a disk block, a file system may use several steps, such as to translate the FBN to a VBN, to translate the VBN to a PBN, and then to translate the PBN to a DBN. Storage containers of various attributes may be defined and utilized using such logical and physical mapping techniques. For example, volumes such as volumes 132A and 132B may be defined to comprise aggregates (e.g., a traditional volume) and/or flexible volumes (e.g., volumes built on top of traditional volumes as a form of virtualization) using such logical and physical data block mapping techniques.

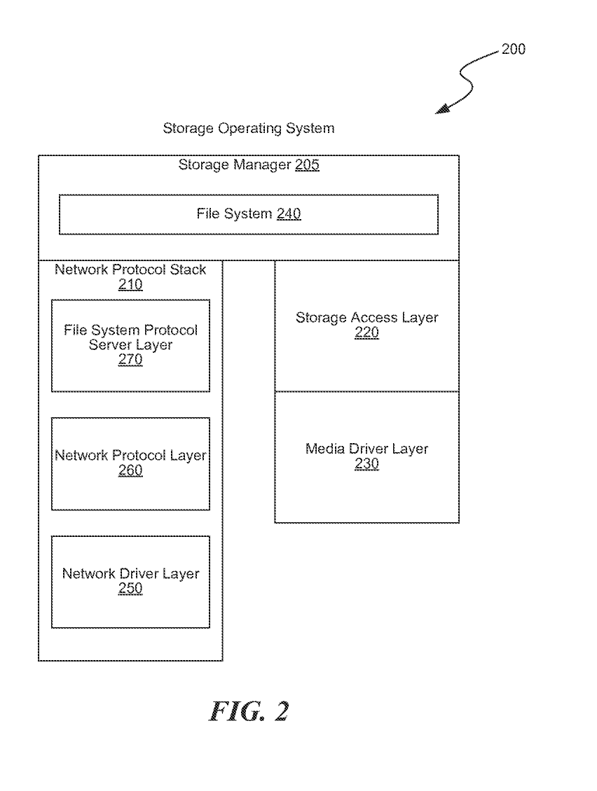

FIG. 2 is a block diagram illustrating a storage operating system, according to various embodiments. As used herein, the term “storage operating system” generally refers to the computer-executable code operable on a computer or a computer cluster to perform a storage function that manages data access and other related functions. Storage operating system 200, can be implemented as a microkernel, an application program operating over a general-purpose operating system, or as a general-purpose operating system configured for the storage applications as described herein. In the illustrated embodiment, the storage operating system 200 includes a network protocol stack 210 having a series of software layers including a network driver layer 250 (e.g., an Ethernet driver), a network protocol layer 260 (e.g., an Internet Protocol layer and its supporting transport mechanisms: the TCP layer and the User Datagram Protocol layer), and a file system protocol server layer 270 (e.g., a CIFS server, a NFS server, etc.). In addition, the storage operating system 200 includes a storage access layer 220 that implements a storage media protocol such as a RAID protocol, and a media driver layer 230 that implements a storage media access protocol such as, for example, a Small Computer Systems Interface (SCSI) protocol. Any and all of the modules of FIG. 2 can be implemented as a separate hardware component. For example, the storage access layer 220 may alternatively be implemented as a parity protection RAID module and embodied as a separate hardware component such as a RAID controller. Bridging the storage media software layers with the network and file system protocol layers is the storage manager 205 that implements one or more file system(s) 240.

Data can be structured and organized by a storage server or a storage cluster in various ways. In at least one embodiment, data is stored in the form of volumes, where each volume contains one or more directories, subdirectories, and/or files. The term “aggregate” is used to refer to a pool of physical storage, which combines one or more physical mass storage devices (e.g., magnetic disk drives or solid state drives) or parts thereof, into a single storage object. An aggregate also contains or provides storage for one or more other data sets at a higher-level of abstraction, such as volumes. A “volume” is a set of stored data associated with a collection of mass storage devices, such as disks, which obtains its storage from (i.e., is contained within) an aggregate, and which is managed as an independent administrative unit, such as a complete file system. A volume includes one or more file systems, such as an active file system and, optionally, one or more persistent point-in-time images of the active file system captured at various instances in time. As stated above, a “file system” is an independently managed, self-contained, organized structure of data units (e.g., files, blocks, or logical unit numbers (LUNs)). Although a volume or file system (as those terms are used herein) may store data in the form of files, which is not necessarily the case. That is, a volume or file system may store data in the form of other units of data, such as blocks or LUNs. Thus, although the discussion herein uses the term “file” for convenience, one skilled in the art will appreciate that the system can be used with any type of data object that can be copied. In some embodiments, the storage server uses one or more volume block numbers (VBNs) to define the location in storage for blocks stored by the system. In general, a VBN provides an address of a block in a volume or aggregate. The storage manager 205 tracks information for all of the VBNs in each data storage system.

In certain embodiments, each file is represented in the storage server in the form of a hierarchical structure called a “buffer tree.” As used herein, the term buffer tree is defined as a hierarchical metadata structure containing references (or pointers) to logical blocks of data in the file system. A buffer tree is a hierarchical structure which can be used to store file data as well as metadata about a file, including pointers for use in locating the data blocks for the file.

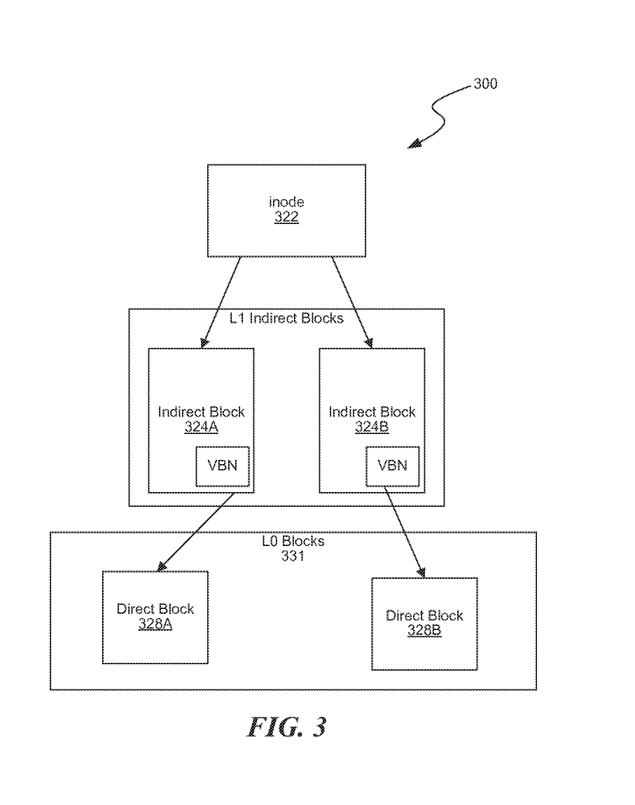

FIG. 3 is a block diagram illustrating a buffer tree of a file, in various embodiments. A file is assigned to an inode 322, which references Level 1 (L1) indirect blocks 324A and 324B. Each indirect block 324 stores at least one volume block number (VBN) that references a direct (L0) block stored on the storage subsystem 110. To simplify description, only one VBN is shown in each indirect block 324 in FIG. 3; however, an actual implementation would likely include multiple/many VBNs in each indirect block 324. Each VBN references a direct block 328A and 328B, respectively, in the storage device.

As illustrated in FIG. 3, a buffer tree includes one or more levels of indirect blocks (called “L1 blocks”, “L2 blocks”, etc.), each of which contains one or more pointers to lower-level indirect blocks and/or to the direct blocks (called “L0 blocks” or “data blocks”) of the file. All of the data in the file is stored only at the lowest level (L0) blocks. The root of a buffer tree is stored in the “inode” of the file. As noted above, an inode is a metadata container that is used to store metadata about the file, such as ownership, access permissions, file size, file type, and pointers to the highest-level of indirect blocks for the file. Each file has its own inode. The inode is stored in a separate inode container, which may itself be structured as a buffer tree. The inode container may be, for example, an inode file. In hierarchical (or nested) directory file systems, this results in buffer trees within buffer trees, where subdirectories are nested within higher-level directories and entries of the directories point to files, which also have their own buffer trees of indirect and direct blocks. Directory entries include the name of a file in the file system, and directories are said to point to (reference) that file. Alternatively, a directory entry can point to another directory in the file system. In such a case, the directory with the entry is said to be the “parent directory,” while the directory that is referenced by the directory entry is said to be the “child directory” or “subdirectory.”

It should be appreciated that the hierarchical logical mapping of a buffer tree can provide indirect data block mapping using multiple levels (shown as levels L0-L2). Data blocks of level L0 comprise the actual data (e.g., user data, application data, etc.) and thus provide a data level. Levels L1 and L2 of a buffer tree can comprise indirect blocks that provide information with respect to other data blocks, wherein data blocks of level L2 provide information identifying data blocks of level L1 and data blocks of level L1 provide information identifying data blocks of level L0. The buffer tree can comprise a configuration in which data blocks of the indirect levels (levels L1 and L2) comprise both logical data block identification information (shown as virtual block numbers (VBNs)) and their corresponding physical data block identification information (shown as physical block numbers (PBNs)). That is, each of levels L2 and L1 has both a VBN and PBN. This format, referred to as dual indirects due to there being dual block numbers in indirect blocks, is a performance optimization implemented according to embodiments herein.

Alternative embodiments may be provided in which the file buffer trees store VBNs without their corresponding PBNs. For every VBN, the system would look up the PBN in another map (e.g., a container map).

In addition, data within the storage server can be managed at a logical block level. At the logical block level, the storage manager maintains a logical block number (LBN) for each data block. If the storage server stores data in the form of files, the LBNs are called file block numbers (FBNs). Each FBN indicates the logical position of the block within a file, relative to other blocks in the file, i.e., the offset of the block within the file. For example, FBN 0 represents the first logical block in a particular file, while FBN 1 represents the second logical block in the file, and so forth. Note that the VBN of a data block is independent of the FBN(s) that refer to that block.

A distributed object storage system can be built based on an underlining file system. The object storage system manages data as objects. Each object can include the data of the object, metadata and a globally unique identifier. A client can access an object using an associated globally unique identifier. Such an object can be implemented, e.g., using one or more files. However, the object does not necessarily belong to any directory of the underlining file system.

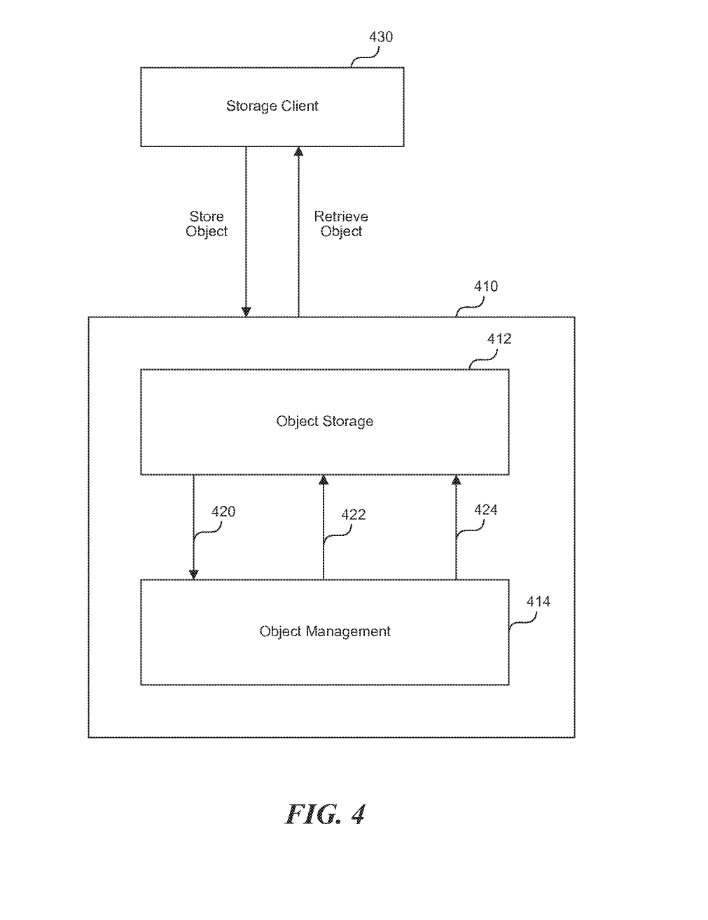

FIG. 4 is a block diagram illustrating components of a distributed object storage system 410, according to various embodiments. The scalability, reliability, and performance problems associated with managing large numbers of objects in a multi-site, multi-tier, fixed-content storage system are addressed through the use of object ownership. One or more clients 430 may access the storage system 410, for example, to place objects into storage or to retrieve previously stored objects.

The Object Storage Subsystem (OSS) 412 is responsible for object storage, object protection, object verification, object compression, object encryption, object transfer between nodes, interactions with client applications, and object caching. For example, any type of fixed content, such as diagnostic images, lab results, doctor notes, or audio and video files, may be stored as objects in the Object Storage Subsystem. The object may be stored using file-access protocols such as CIFS (Common Internet File System), NFS (Network File System) or HTTP (Hypertext Transfer Protocol). There may be multiple Object Storage Subsystems in a given topology, with each Object Storage Subsystem maintaining a subset of objects. Redundant copies of an object may be stored in multiple locations and on various types of storage media, such as optical drives, hard drives, magnetic tape or flash memory.

The Object Management Subsystem (OMS) 414 is responsible for managing the state of objects within the system. The Object Management Subsystem 414 stores information about the state of the objects and manages object ownership within in the distributed fixed-content storage system.

State updates 420 can be triggered by client operations or by changes to the storage infrastructure that is managed by the Object Storage Subsystem 412. Object alteration actions 424 are generated by the Object Management Subsystem 414 in response to state updates 420. Examples of object alteration actions 424 include, for example, metadata storage, object location storage, object lifecycle management, and Information Lifecycle Management rule execution. Processing of state updates 420 and the resulting object alteration actions 424 can be distributed among a network of computing resources. The Object Management Subsystem may also perform object information actions 422 that do not alter the state on an object and may include metadata lookup, metadata query, object location lookup, and object location query.

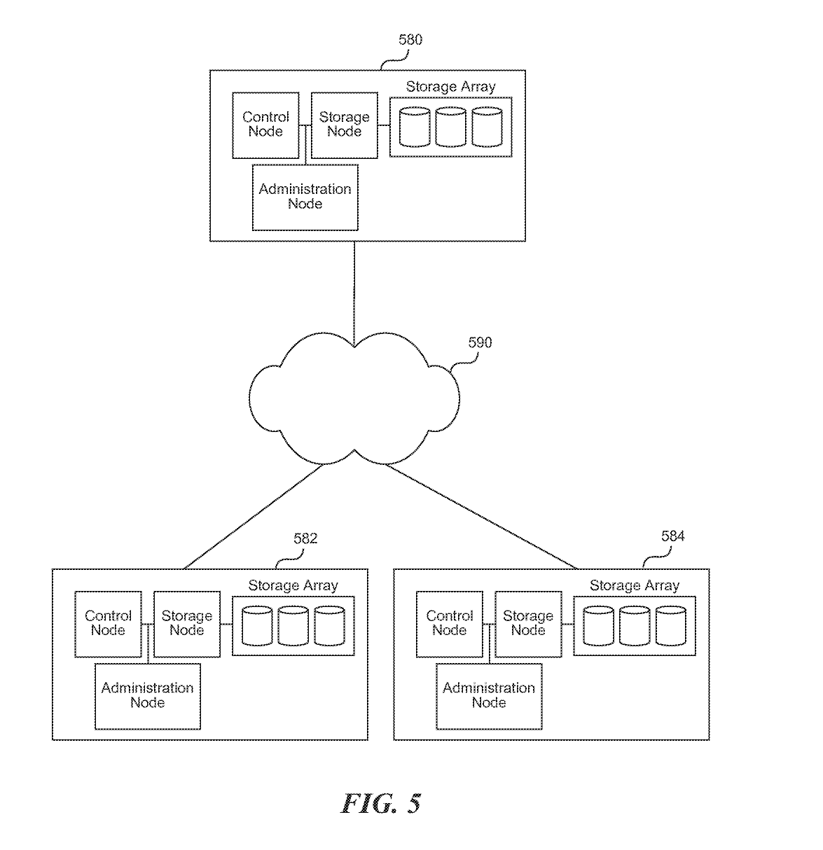

The object storage system can include servers that locate at different geographical sites. FIG. 5 is a block diagram illustrating a geographically distributed site servers of an object storage system. These site servers (also referred to as sites) can be connected with a Wide-Area Network 590 comprised of, for example, T1 and T3 network connections and IP routers allowing TCP/IP connectivity from any site to any other site. The Information Lifecycle Management rules can configured such that data input into the system at site 580 is initially replicated to site 582. The data may be propagated to other sites, such as site 584, at periodic intervals. For example, the data may be replicated to site 584 one month from the time of first ingest.

At each site, there can be multiple configured servers. The first server is designated as the “Control Node” and runs an instance of database (e.g., MySQL) or key-value store (e.g., Apache Cassandra) and the Content Metadata Service. This server manages the stored objects. The second server is designated as the “Storage Node” and runs the Local Distribution Router (“LDR”) service. The Storage Node is connected to a storage array, such as a RAID-5 Fiber Channel attached storage array. In this example, three sites can have identical, similar or different hardware and software configurations. The object storage system formed by these three sites is used by a record management application for the storage of digital objects. The record management system interfaces with the object storage system using, e.g., the HTTP protocol. The third server is designated as the “Administration Node.” The Administration Node can include an information lifecycle management interface.

For example, the record management application opens an HTTP connection to the Storage Node in Site 580 and performs an HTTP PUT operation to store a digital object. At this point a new object is created in the Storage Grid. The object is protected and stored on the external storage of the Storage Node by the Local Distribution Router service. Metadata about the newly stored object is sent to the Content Metadata Service on the Control Node, which creates a new entry for the object. According to rules specifying the degree of replication of the metadata information, an additional copy of the metadata can be created in Site 582.

An instance of the records management system at site 582 requests to read the document by performing an HTTP GET transaction to the storage node in Site 582. At this point the Local Distribution Router service on that Storage Node requests metadata information about the object from the Control Node in Site 582. In this case, the metadata is read directly from Site 582 (a read operation).

After one month has elapsed, Information Lifecycle Rules may dictate that a copy of the object is required in Site 584. The Owner Content Metadata Service at Site 580 initiates this action. Once this additional copy is made, the updated metadata indicating the presence of the new copy is sent to the Content Metadata Service in Site 584. The message containing the modification request is forwarded to the Content Metadata Service in Site 580 based on the information contained in the metadata for the object.

The combination of these steady state and failure condition behaviors permit continued and provable correct operation in all cases where sufficient resources are available, and require the minimal expenditure of computing resources. The property that the computing resources required to manage objects grows linearly with the number of objects allows the system to scale to handle extremely large numbers of objects, thus fulfilling the business objectives of providing large scale distributed storage systems.

For a particular data object, a client can specify the Information Lifecycle Management rules to decide the number of copies (also referred to as replicas) stored at an object storage system. The object storage system ensures that the metadata and the data of the data object are consistent. For example, if the data object has only one copy stored at the object storage system (i.e., a single-copy object), and the single-copy object is corrupt, the object storage system can clean up the metadata of the single-copy object. The object storage system can further avoid locating other storage locations of the single-copy object, because the object storage system does not store any other copies of the object.

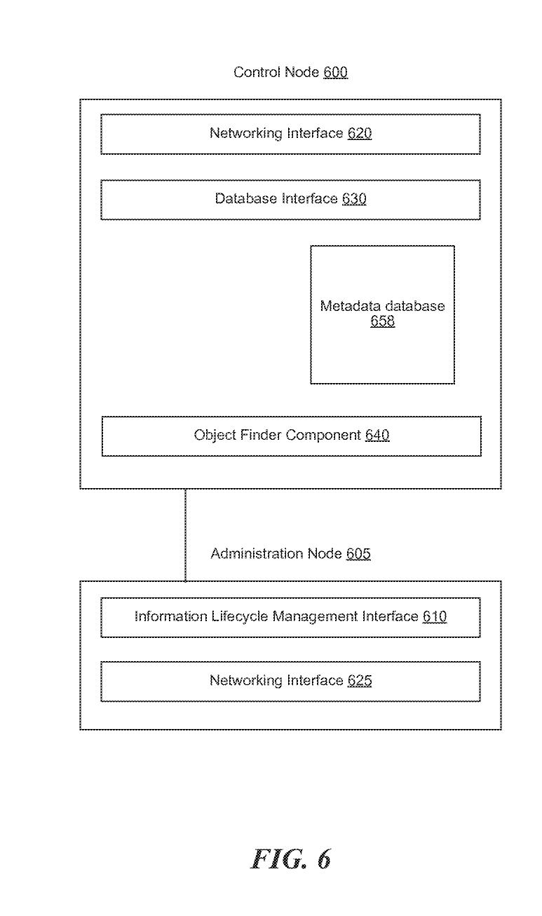

FIG. 6 is a block diagram illustrating components of a control node and an administration node of an object storage system. The control node 600 includes a networking interface 620, a database interface 630 and an object finder component 640. The administration node includes an information lifecycle management interface 610 and a networking interface 625. The information lifecycle management interface 610 can set up user-defined policies based on client instructions. For example, the information lifecycle management interface 610 can set up a policy that only one copy of an individual data object is stored in the object storage system. The networking interface 625 enables the administration node 605 to communicate with other entities such as control node 600 and storage node.

The networking interface 620 is configured to receive user requests for retrieving data of data objects and send out reply messages in response to the received user requests.

The database interface 630 is configured to identify a storage location of the data object based on metadata of the data object retrieved from a metadata database 650 of the object storage system. The metadata database 650 can be an internal component within the control node 600, or an external component hosted by other nodes of the object storage system. Alternatively, the metadata database can be a distributed database stored across multiple node of the object storage system.

Once the database interface 630 identifies a storage location of the data object, the networking interface 620 sends a data request to a storage node of the object storage system based on the storage location. If the networking interface 620 receives the data of the data object, the networking interface 620 further relays the data to the client that initiates the data request. However, in some situations, the networking interface 620 may receive an error message indicating that the storage node no longer has the storage object.

Once the error message is received, the data interface 630 can inquire the metadata database 650 to identify other storage location of the data object. If there is other storage location, the object finder component 640 can perform a data recovery process for retrieving data of the object from another storage location. For example, the object finder component 640 can iterate through different possible storage locations and checks whether storage servers associated with the storage locations has a copy of the data object. If the user-defined policy has specified that only one copy of the data object is stored in the object storage system, the object finder component 640 voids a data recovery process for the storage object.

When the data of the single-copy object is no longer available, the database interface 630 further remove the metadata of the data object from the metadata database so that the metadata records are consistent with the data of the data object.

The networking interface 620 can send a message indicating that the storage object is lost to the client that initiates the data request. The message can include a last know location of the storage object. The information lifecycle management interface 610 can also display an alarm reporting that the storage object is lost. The information lifecycle management interface 610 can present a user interface element to reset the alarm.

In some embodiments, the storage of data objects is realized based on a file system. For example, the data of the data object can be stored in one or more data files. The storage location of the data object identifies a storage node of the object storage system that stored the one or more data files. The storage location of the data object can further identify directory locations of the one or more data files within a file system of the storage node.

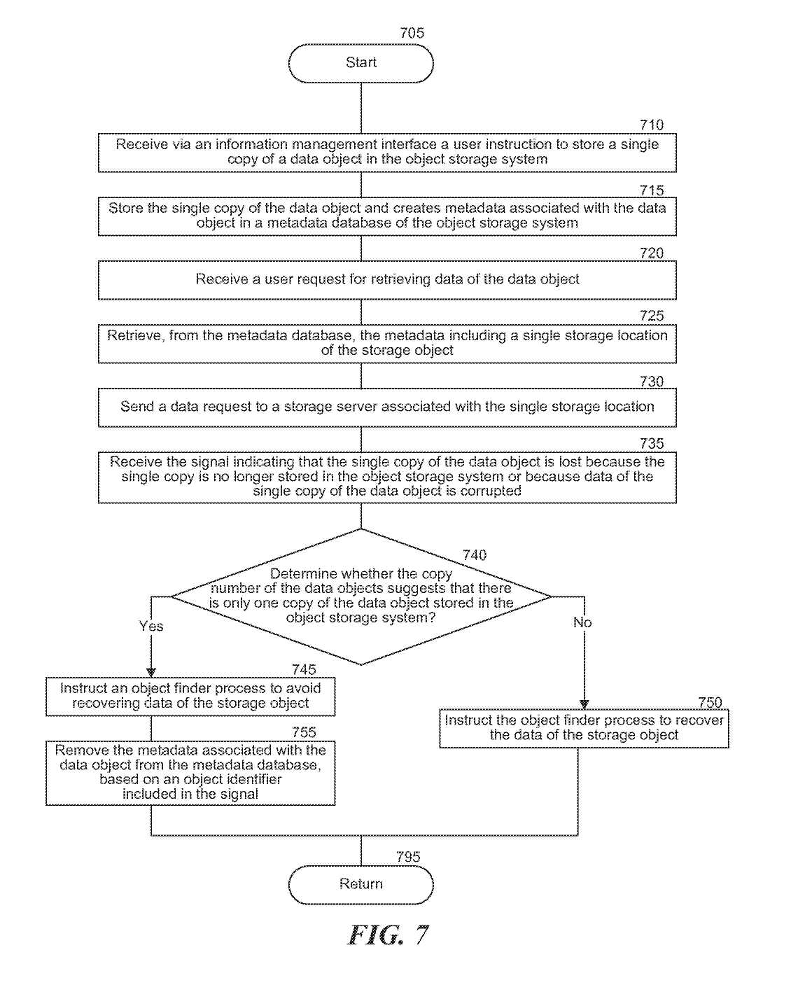

FIG. 7 is a flow diagram illustrating a process for maintaining consistency between data and metadata of an object storage system, in various embodiments. The process starts at block 705. At block 710, the object storage system receives via an information lifecycle management interface a user instruction to store a single copy of a data object in the object storage system. Alternatively, the user instruction specifies a storage configuration (e.g., a number of copies, or designating as low value data) of a data object stored in the object storage system. In response to the user instruction, at block 715, the object storage system stores the single copy of the data object and creates metadata associated with the data object in a metadata database of the object storage system. The metadata can, e.g., includes a copy number of the data object. In various alternative embodiments, the object storage system can determine the number of copies of the data object based on a list of locations of the copies. In some other embodiments, the metadata can, e.g., include one or more records indicating the number of total or additional copies of the data object.

At block 720, the object storage system receives a user request for retrieving data of the data object. To satisfy the request, at block 725, the object storage system retrieves, from the metadata database, the metadata including a single storage location of the storage object. At block 730, based on the single storage location, the object storage system sends a data request to a storage server associated with the single storage location.

At block 735, the object storage system receives the signal indicating that the single copy of the data object is lost because the single copy is no longer stored in the object storage system or because data of the single copy of the data object is corrupted. The communications between the object storage system and the storage server can be based on, e.g., Transmission Control Protocol (TCP) protocol. In some embodiments, the storage object is actually implemented by one or more data files. The object storage system can directly sends the data request to retrieve the data of the underlying data files. When the storage server discovers that at least one of the underlying data files is missing or corrupt, the storage server sends the signal to the object storage system indicating the loss of the data object.

In response to the signal, at decision block 740, the object storage system determines whether the copy number of the data objects suggests that there is only one copy of the data object stored in the object storage system. If the copy number suggests that there is only one copy, at block 745, the object storage system instructs an object finder process to avoid recovering data of the storage object. For example, the object storage system instructs the object finder process to avoid trying to find other copies of the storage object. If the copy number suggests that there is more than one copy, at block 750, the object storage system instructs the object finder process to recover the data of the storage object. In some embodiments, the object finder process is a background task that tries to find potential locations of the data object.

In some embodiments, the object storage system determines whether there is only one copy of the data object stored in the object storage system by consulting the user instruction provided at step 710 via the information lifecycle management interface.

By instructing the object finder to avoid recovering data of the storage object, the object storage system optimizes the performance of the system by avoiding wasting resources on recovering data that no longer exist in the object storage system. The object storage system recognizes the loss of the data object and moves on to conduct other storage tasks using the available hardware resources.

When there is only one copy of the object, at block 755, the object storage system further removes the metadata associated with the data object from the metadata database, based on an object identifier included in the signal. When the single copy of the data object is lost or corrupt, the metadata of the data object is no longer needed. The object storage system improves the storage space efficiency by removing the metadata. Furthermore, the consistency between the data and the metadata is conserved, as both the data and metadata of the lost data object are removed from the object storage system.

In some embodiments, the metadata are stored in a database (e.g., the metadata database 658 as illustrated in FIG. 6). The object storage system can use a unique identification of the lost data object (e.g., an object id) to identify any database entries that relate to the lost data object. The object storage system can instruct the database to remove the database entries that record the metadata of the lost data object based on the unique identification so that the storage space occupied by the database is reduced. The database can be either standalone database residing in a node of the object storage system, or a distributed database occupied spaces of multiple nodes of the object storage system.

Those skilled in the art will appreciate that the logic illustrated in FIG. 7 and described above, and in each of the flow diagrams discussed below, may be altered in a variety of ways. For example, the order of the logic may be rearranged, substeps may be performed in parallel, illustrated logic may be omitted, other logic may be included, etc.

As FIG. 7 illustrates, a request to retrieve the data of the data object can trigger the cleanup process. In some embodiments, the scanning of the integrity of the stored data objects can trigger the cleanup process as well. A user can manually start the scanning task. Alternatively, the scanning of the stored data objects can be part of the regular maintenance procedures of the object storage system

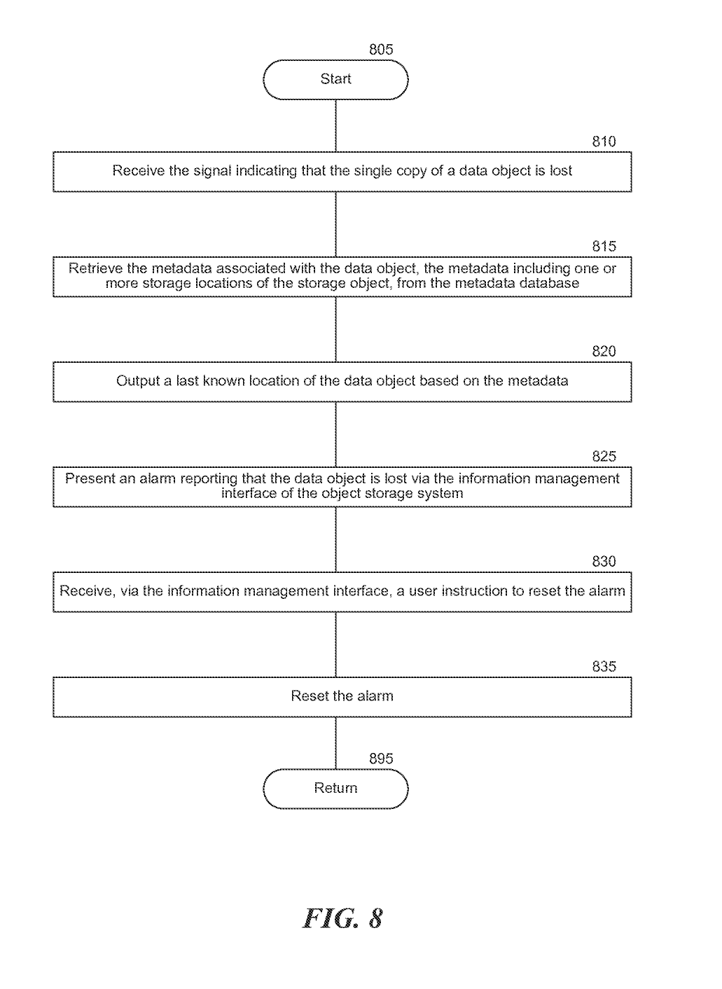

Before the object storage system remove the associated metadata, the object storage system can notify the loss of the data object. FIG. 8 is a flow diagram illustrating a process for notifying a loss of a data object, in various embodiments. The process starts at 805. At block 810, the object storage system receives the signal indicating that the single copy of a data object is lost.

At block 815, the object storage system retrieves the metadata associated with the data object, the metadata including one or more storage locations of the storage object, from the metadata database. At block 820, the object storage system outputs a last known location of the data object based on the metadata. In some embodiments, the last known location can be included in an audit message sent to the user of the object storage system. If the user may use the last known location for trouble shooting purpose. Alternatively, the user may use the last known location for historical record keeping purpose. The last known location can be or can include, e.g., an identifier or a description of the storage node that is lastly known for physically storing the lost data object. In some other embodiments, the last known location can include the file system directory locations for storing the files that implemented the lost storage object.

Further in response to the signal, at block 825, the object storage system presents an alarm reporting that the data object is lost via the information lifecycle management interface of the object storage system. The alarm can be an icon, a message, a color code, or any interface element that can draw attention of the user who operates the information lifecycle management interface. The alarm can also include an identifier or a name of the data object. After the user is aware of the alarm of the lost data object, the user may choose to reset (e.g., turn off) the alarm. The inform management interface can provide an element, e.g., a check box for the user to reset the alarm. At block 830, the object storage system receives, via the information lifecycle management interface, a user instruction to reset the alarm. At block 835, the object storage system resets the alarm.

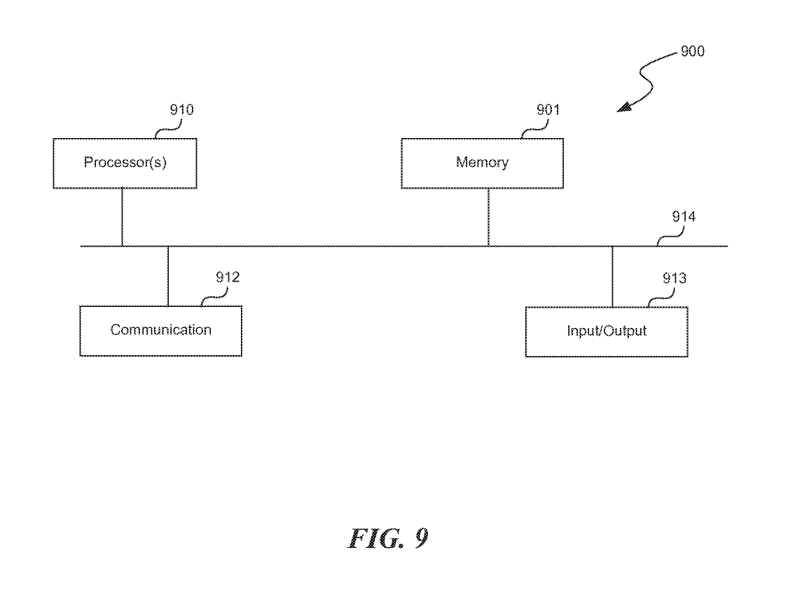

FIG. 9 is a high-level block diagram showing an example of computer system in which at least some operations related to technology disclosed herein can be implemented. In the illustrated embodiment, the computer system 900 includes one or more processors 910, memory 911, a communication device 912, and one or more input/output (I/O) devices 913, all coupled to each other through an interconnect 914. The interconnect 914 may be or include one or more conductive traces, buses, point-to-point connections, controllers, adapters and/or other conventional connection devices. The processor(s) 910 may be or include, for example, one or more general-purpose programmable microprocessors, microcontrollers, application specific integrated circuits (ASICs), programmable gate arrays, or the like, or a combination of such devices. The processor(s) 910 control the overall operation of the computer device 900.

Memory 911 may be or include one or more physical storage devices, which may be in the form of random access memory (RAM), read-only memory (ROM) (which may be erasable and programmable), flash memory, miniature hard disk drive, or other suitable type of storage device, or a combination of such devices. Memory 911 may store data and instructions that configure the processor(s) 910 to execute operations in accordance with the techniques described above. The communication device 912 may be or include, for example, an Ethernet adapter, cable modem, Wi-Fi adapter, cellular transceiver, Bluetooth transceiver, or the like, or a combination thereof. Depending on the specific nature and purpose of the computer device 900, the I/O devices 913 can include devices such as a display (which may be a touch screen display), audio speaker, keyboard, mouse or other pointing device, microphone, camera, etc.

Unless contrary to physical possibility, it is envisioned that (i) the methods/steps described above may be performed in any sequence and/or in any combination, and that (ii) the components of respective embodiments may be combined in any manner.

The techniques introduced above can be implemented by programmable circuitry programmed/configured by software and/or firmware, or entirely by special-purpose circuitry, or by a combination of such forms. Such special-purpose circuitry (if any) can be in the form of, for example, one or more application-specific integrated circuits (ASICs), programmable logic devices (PLDs), field-programmable gate arrays (FPGAs), etc.

Software or firmware to implement the techniques introduced here may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium includes recordable/non-recordable media (e.g., read-only memory (ROM); random access memory (RAM); magnetic disk storage media; optical storage media; flash memory devices; etc.), etc.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the technology is not limited except as by the appended claims.

What is claimed is:

1. A method, comprising:
receiving, via an information lifecycle management interface of an object storage system, a user instruction specifying a storage configuration of a data object to be stored in the object storage system;
in response to the user instruction, storing a single copy of the data object in the object storage system and creating metadata associated with the data object in a metadata database of the object storage system, the metadata including a copy number of the data object;
receiving a signal indicating that no copy of the data object can be found or accessed;
in response to the signal, determining that the copy number of the data objects indicates that there is only one copy of the data object stored in the object storage system; and
based on an object identifier included in the signal, removing the metadata associated with the data object from the metadata database.

2. The method of claim 1, further comprising:
instructing an object finder process of the object storage system to avoid recovering data of the storage object; and
wherein the user instruction specifies that a single copy of the data object is to be stored in the object storage system.

3. The method of claim 1, further comprising:
retrieving, from the metadata database, the metadata associated with the data object, the metadata including one or more storage locations of the storage object; and
outputting a last known location of the data object based on the metadata.

4. The method of claim 1, further comprising:
in response to the signal, presenting an alarm reporting that the data object is lost via the information lifecycle management interface of the object storage system; and
receiving, via the information lifecycle management interface, a user instruction to reset the alarm.

5. The method of claim 1, further comprising:
receiving a user request for retrieving data of the data object;
retrieving, from the metadata database, the metadata associated with the data object, the metadata including a single storage location of the storage object; and
based on the single storage location, sending a data request to storage server associated with the single storage location.

6. The method of claim 1, wherein the receiving of the signal comprises:
receiving the signal indicating that the single copy of the data object is lost because the single copy is no longer stored in the object storage system or because data of the single copy of the data object is corrupted.

7. The method of claim 1, wherein the instructing of the object finder process comprises:
instructing the object finder process of the object storage system to avoid trying to find other copies of the storage object.

8. A control node of an object storage system, comprising:
an information lifecycle management interface configured to set up a user-defined policy that only one copy of an individual data object is stored in the object storage system;
a networking interface configured to receive a user request for retrieving data of the data object; and
a database interface configured to identify a storage location of the data object based on metadata of the data object retrieved from a metadata database of the object storage system;
the networking interface further configured to send to a storage node of the object storage system a data request based on the storage location, and to receive an error message indicating that the storage node no longer has the storage object; and
the database interface further configured to remove the metadata of the data object from the metadata database.

9. The control node of claim 8, further comprising:
an object finder component configured to avoid a data recovery process for the storage object, in response to the user-defined policy that only one copy of the data object is stored in the object storage system.

10. The control node of claim 8, wherein the networking interface is further configured to send a message indicating that the storage object is lost, the message including a last know location of the storage object.

11. The control node of claim 8, wherein the information lifecycle management interface is further configured to display an alarm reporting that the storage object is lost.

12. The control node of claim 11, wherein the information lifecycle management interface is further configured to reset the alarm in response to a user instruction.

13. The control node of claim 8, wherein the control node further comprises the metadata database, or the metadata database is a distributed database stored across multiple node of the object storage system.

14. The control node of claim 8, wherein data of the data object is stored in one or more data files, and the storage location of the data object identifies a storage node of the object storage system that stored the one or more data files.

15. The control node of claim 14, wherein the storage location of the data object identifies directory locations of the one or more data files within a file system of the storage node.

16. A non-transitory machine readable medium having stored thereon instructions for performing a method of maintaining consistency between data and metadata of an object storage system, comprising machine executable code which when executed by at least one machine, causes the machine to:
enforce an information management policy that only a single copy of a storage object is stored in the object storage system;
avoid a recovery process for recovering data of the storage object in response to a message from a storage node of the object storage system indicating that the storage object is lost; and
remove metadata associated with the storage object from the object storage system.

17. The non-transitory machine readable medium of claim 16, wherein the machine executable code which when executed by at least one machine, further causes the machine to:
remove metadata associated with the storage object from a metadata database of the object storage system.

18. The non-transitory machine readable medium of claim 16, wherein the machine executable code which when executed by at least one machine, further causes the machine to:
store the single copy of the storage object in a storage node of an object storage system; and
store an object location of the single copy of the storage object in a metadata database as a portion of metadata of the storage object.

19. The non-transitory machine readable medium of claim 18, wherein the machine executable code which when executed by at least one machine, further causes the machine to:
identify the object location of the data object stored in the metadata database; and
forward a data request for the data object to the storage node according to the object location.

20. The non-transitory machine readable medium of claim 16, wherein the machine executable code which when executed by at least one machine, further causes the machine to:
generate the information management policy based on a legal requirement that the object storage system can only store a single copy of the storage object.
